(19) United States
(12) Patent Application Publication
(10) Pub. No.: US 2026/0179122 A1
(43) Pub. Date: Jun. 25, 2026

(54) INFORMATION PROCESSING APPARATUS, INFORMATION PROCESSING METHOD, AND INFORMATION PROCESSING PROGRAM

(71) Applicant: SoftBank Group Corp., Tokyo (JP)

(72) Inventors: Naoki KUSUMOTO, Tokyo (JP); Somin PARK, Tokyo (JP)

(21) Appl. No.: 19/429,594

(22) Filed: Dec. 22, 2025

(30) Foreign Application Priority Data
Dec. 24, 2024 (JP) 2024-227246
Dec. 9, 2025 (JP) 2025-243694

(51) Int. Cl. G06Q 30/0251; G06Q 30/0242

(52) U.S. Cl. CPC G06Q 30/0259; G06Q 30/0242; G06Q 30/0267

(57) ABSTRACT

An information processing apparatus according to the embodiment includes a control unit. The control unit collects regional data for each region, analyzes a situation of an area where a customer store is located based on the collected regional data, and, when the timing for a promotion for the store is detected based on an analysis result of an area situation, instructs a generative AI to generate promotion data for the promotion, presents the promotion data generated by the generative AI to a store terminal of the store, and, when an approval response to the promotion data is obtained from the store terminal, distributes the promotion data to user terminals used by general users.

### CROSS-REFERENCE TO RELATED APPLICATION

The present application claims priority to and incorporates by reference the entire contents of Japanese Patent Application No. 2024-227246 filed in Japan on Dec. 24, 2024 and Japanese Patent Application No. 2025-243694 filed in Japan on Dec. 9, 2025, the entire contents of which are incorporated herein by reference.

### BACKGROUND OF THE INVENTION

### 1. Field of the Invention

The embodiment disclosed herein relates to an information processing apparatus, an information processing method, and an information processing program.

### 2. Description of the Related Art

Conventionally, technologies are known for conducting promotions to attract customers to stores by distributing advertisements, coupons, and the like to user terminals such as smartphones used by general users. For example, Japanese Unexamined Patent Publication No. 2002-288506 discloses a coupon distribution system that acquires location information of user terminals and behavioral information of users, and distributes coupons for stores that a user has accessed, in order of proximity to the current location of the user terminal.

However, the above-described conventional technology still has room for further improvement in realizing more efficient and effective promotions.

For example, the above-described conventional technology merely targets users who have accessed a store's website and are currently near the store, for promotions. Therefore, it cannot target users who have accessed a store but are not near the store, or users who have not accessed a store but happen to be near the store because they are participating in events in an area where the store is located.

In other words, the conventional technology lacks a method for delivering timely and appropriate promotion information to users for attracting customers to stores. However, for a store side to set up effective promotions to deliver such timely and appropriate promotion information is a very labor-intensive task for the store.

### SUMMARY OF THE INVENTION

An information processing apparatus according to one aspect of the embodiment includes a control unit. The control unit collects regional data for each region, analyzes a situation of an area where a customer store is located based on the collected regional data, and, when the timing for a promotion for the store is detected based on the analysis result of the area situation, instructs a generative AI to generate promotion data for the promotion, presents the promotion data generated by the generative AI to a store terminal of the store, and, when an approval response to the promotion data is obtained from the store terminal, distributes the promotion data to user terminals used by general users.

### BRIEF DESCRIPTION OF THE DRAWINGS

FIG. 1 is a schematic explanatory diagram (Part 1) of a promotion service provision method according to an embodiment;

FIG. 2 is a schematic explanatory diagram (Part 2) of a promotion service provision method according to the embodiment;

FIG. 3 is a diagram showing an example configuration of a promotion system according to the embodiment;

FIG. 4 is a diagram showing an example configuration of a promotion server according to the embodiment;

FIG. 5 is a diagram showing an example of usage data in regional data;

FIG. 6 is an explanatory diagram of promotion types;

FIG. 7 is a diagram showing an example of area coverage type promotion;

FIG. 8 is a diagram showing a processing sequence executed by the promotion system according to the embodiment, and

FIG. 9 is a schematic diagram showing an example hardware configuration of a computer functioning as the promotion server.

### DETAILED DESCRIPTION OF THE PREFERRED EMBODIMENTS

Hereinafter, the present disclosure will be described through embodiments, but the following embodiments do not limit an invention according to a scope of claims. Further, not all combinations of features described in the embodiments are necessarily essential for a solution method of the invention.

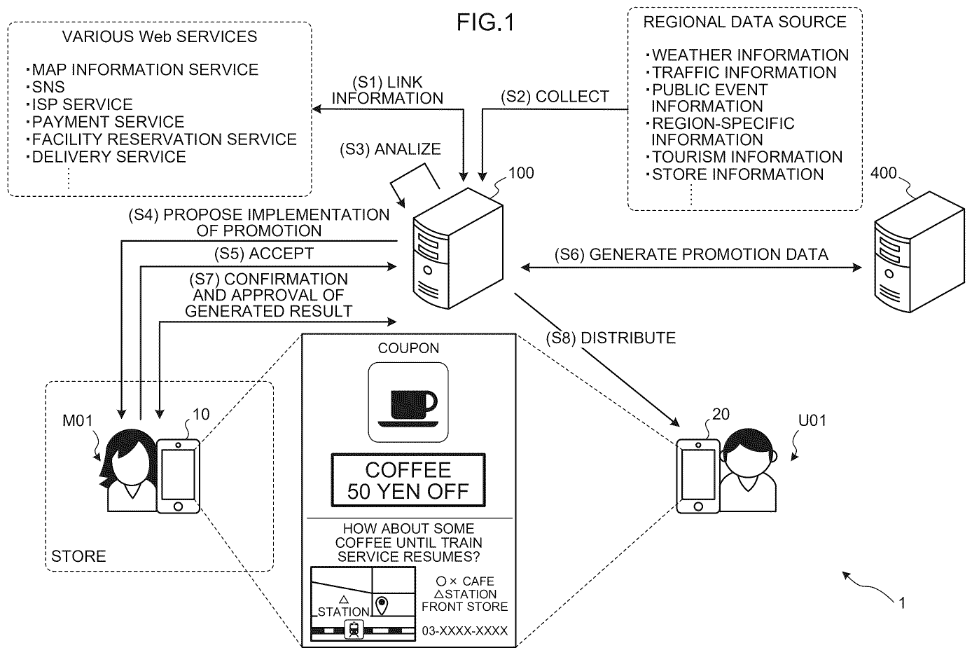

In the following, an information processing system according to the embodiment will be described by way of example as a promotion system 1 (see FIG. 1). Also, in the following, the information processing apparatus according to the embodiment is assumed to be a promotion server 100 included in the promotion system 1 (see FIG. 1).

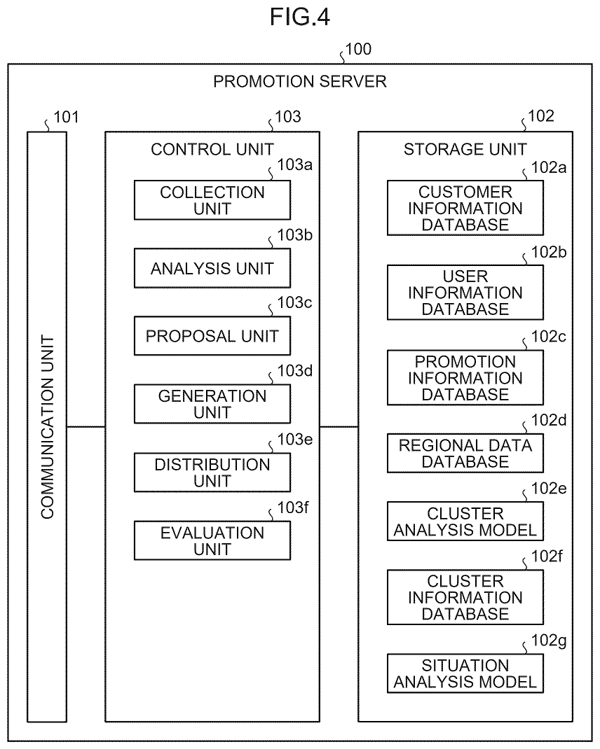

The promotion server 100 is a server device that provides promotion services for attracting customers to stores, which are customers, in the promotion system 1. The information processing method according to the embodiment is a promotion service provision method executed by a control unit 103 (see FIG. 4) provided in the promotion server 100.

In addition, when it is necessary to distinguish between multiple identical elements, numbering may be added in the format “−k” (where k is a natural number) after a reference numeral indicating the element. If there is no particular need to distinguish, such numbering will not be performed.

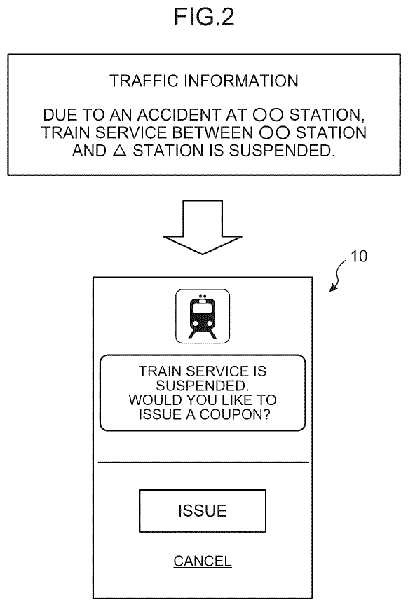

First, the outline of the promotion service provision method according to the embodiment will be described with reference to FIG. 1 and FIG. 2. FIG. 1 is a schematic explanatory diagram (Part 1) of the promotion service provision method according to the embodiment. FIG. 2 is a schematic explanatory diagram (Part 2) of the promotion service provision method according to the embodiment.

As shown in FIG. 1, the promotion system 1 includes a store terminal 10, a user terminal 20, a promotion server 100, and a generative AI (Artificial Intelligence) server 400.

The store terminal 10 is a terminal device used by an operator M01 who is in charge of promotions for their own store at the store. The operator M01 refers to, for example, a store owner or an employee in charge of promotions. The store terminal 10 may be implemented by a computer such as a PC (Personal Computer) including a tablet type, a smartphone, or a wearable device.

The user terminal 20 is a terminal device used by a general user U01 who may be a target for attracting customers from the store side. Like the store terminal 10, the user terminal 20 may also be implemented by a computer such as a PC, a smartphone, or a wearable device.

As described above, the promotion server 100 is a server device that provides promotion services for attracting customers to stores, which are customers. The promotion service referred to herein is, for example, a support service for delivering timely and appropriate promotion information to the user U01 for attracting customers to stores. The promotion server 100 is a server device operated and managed by a business operator providing such promotion services, and may be implemented as a private cloud, for example. Note that the promotion server 100 may also be implemented as a public cloud.

The generative AI server 400 is a server device functioning as a so-called generative AI. The generative AI server 400 has a generative AI model (not shown). By loading such a generative AI model as part of its program and operating, the generative AI server 400 functions as a generative AI that generates responses to prompts input from the promotion server 100 and outputs the generated responses to the promotion server 100.

The generative AI model is, for example, a multimodal large language model capable of accepting multiple types of inputs as modalities such as text, images, and audio. The generative AI model may be, for example, a transformer-based model or an RNN (Recurrent Neural Network)-based model.

The transformer-based model may be, for example, GPT (Generative Pre-trained Transformer) or BARD (Bidirectional Auto Regressive Dialogues), but is not limited to the examples. The RNN-based model may be, for example, RWKV (Receptance Weighted Key Value), but is not limited to the examples. Note that the generative AI model may also be a unimodal large language model that accepts only text.

The generative AI model may be customized (so-called “fine-tuning”) according to promotion support operations in the promotion system 1, for example. In this case, the generative AI server 400 may be implemented as a private cloud, but may also be implemented as a public cloud.

In the promotion service provision method according to the embodiment, in such a promotion system 1, the promotion server 100 collects regional data for each region and analyzes a situation of an area where a customer store is located based on the collected regional data. Further, when the promotion server 100 detects a timing for a promotion for the store based on analysis result of the area situation, it instructs the generative AI to generate promotion data for the promotion. The promotion server 100 presents the promotion data generated by the generative AI to a store's store terminal, and, when an approval response to the promotion data is obtained from the store terminal, distributes the promotion data to user terminals used by the general users U01. Note that the area situation includes not only simple congestion levels but also background factors (namely, context) such as “why is it crowded (returning from an event, traffic jam due to an accident)”.

Specifically, as shown in FIG. 1, the promotion server 100 executes the promotion service provision method according to the embodiment while linking information with various web services (Step S1). The various web services include, for example, map information services, SNS (Social Networking Service), ISP (Internet Service Provider) services, payment services, facility reservation services, delivery services, and the like.

While appropriately linking information with such various web services, the promotion server 100 collects various types of regional data from regional data sources (Step S2). The regional data is data related to each region where customer stores are located. Note that the regional data source may include at least some of the various web services as data sources.

The regional data is information associated with a specific geographic area, and is a broad concept that includes not only static information (namely, facility information, topographical information, etc.) but also dynamic information that changes over time (namely, weather data, transportation operation status, normal traffic volume, people flow data, trending words on SNS, disaster prevention radio information from local governments, etc.). The regional data includes, for example, weather information, traffic information, public event information, region-specific information, tourism information, store information, and the like. The store information includes, for example, a store's location, business hours, off-peak hours, business status including availability, review ratings, and menu information for restaurants, etc. The weather information includes information such as average precipitation and average temperature. The store information may include store information of stores other than customers.

Then, the promotion server 100 performs real-time situation analysis based on the collected regional data (Step S3). For example, the promotion server 100 determines an optimal timing for a promotion for a customer store located in the area indicated by certain regional data. When the promotion server 100 detects arrival of such optimal promotion timing, it proposes implementation of the promotion to the store's store terminal 10 (Step S4).

A specific example is shown in FIG. 2. As shown in FIG. 2, suppose the promotion server 100 acquires traffic information as certain regional data, such as “Train operations between XX Station and ΔStation are suspended due to an accident at XX Station.” Then, the promotion server 100 presents a proposal to the store terminals 10 of customer stores located around XX Station and ΔStation, such as “Train service is suspended. Would you like to issue a coupon?”

Returning to explanation of FIG. 1. When the operator M01 accepts a proposal by operating an “Issue” button shown in FIG. 2 (Step S5), the promotion server 100 generates promotion data in cooperation with the generative AI server 400 (Step S6). The promotion data refers to any digital content distributed to the user terminals 20 to stimulate the user U01's motivation to visit or make a purchase, such as electronic coupons, advertisement text, banner images, map pin highlighting, push notification messages, etc. In this embodiment, coupons will mainly be used as examples.

In Step S6, the promotion server 100 inputs a prompt to the generative AI server 400 to generate a coupon for a store that has accepted implementation of the promotion, using, for example, information linked with various web services and regional data. The promotion server 100 also acquires the coupon generated by the generative AI server 400 as a response to the prompt.

Then, the promotion server 100 presents a coupon acquired from the generative AI server 400 to the store terminal 10, and exchanges confirmation and approval of the generated result (i.e., the coupon) with the store terminal 10 (Step S7). If approval from the operator M01 is not obtained from the store terminal 10, the promotion server 100 repeats Steps S6 to S7, instructing the generative AI server 400 to regenerate the coupon.

When approval is obtained, the promotion server 100 distributes a coupon to the user terminal 20 of the target user U01 (Step S8). FIG. 1 shows an example in which the generated coupon is a coffee discount coupon issued by a cafe located near Δ Station (see FIG. 2), where train service is suspended.

In such an example, the promotion server 100 targets, for example, the users U01 who are within a predetermined range from ΔStation, or the users U01 who routinely use Δ Station for commuting or school during the time when train service is suspended.

As described above, in the promotion service provision method according to the embodiment, the promotion server 100 collects regional data for each region and analyzes a situation of an area where a customer store is located based on the collected regional data. Further, when the promotion server 100 detects a timing for a promotion for a store based on the analysis result of the area situation, it instructs the generative AI to generate promotion data for promotion. The promotion server 100 presents the promotion data generated by the generative AI to the store terminal 10 of the store, and, when an approval response to the promotion data is obtained from the store terminal 10, distributes the promotion data to user terminals 20 used by the general users U01.

Therefore, according to the promotion service provision method of the embodiment, for example, a store side does not have to spend time on promotion operations such as generating and distributing promotion data to deliver timely and appropriate promotion information to the user U01. Furthermore, even without a store side conducting such promotion operations, effective promotion data is automatically generated using a generative AI in response to real-time changes in a situation to be presented to the store side. That is, according to the promotion service provision method of the embodiment, it is possible to realize more efficient and effective promotions.

Conventional promotion systems generally use methods triggered by user location information or attribute information (such as age and gender). However, with this method, it is necessary to wait for changes in user behavior, making it difficult for a store side to proactively respond to sudden environmental changes (such as sudden heavy rain or train delays).

In contrast, in the promotion service provision method of the present embodiment, by using a generative AI model (LLM), it is possible to generate promotions that take into account “context” that cannot be expressed by numerical threshold judgments alone.

In the promotion service provision method of the present embodiment, for example, by combining factual data such as “a delay due to an accident has occurred at the station,” attribute data such as “the store is a cafe located in front of the station,” and time data such as “the current time is during the evening rush hour,” it is possible to automatically generate a natural language promotion proposal that matches a situation at that moment and appeals to user's emotions, such as “While waiting for the train to resume, why not take shelter from the rain with a hot coffee?” without human intervention.

According to the promotion service provision method of the present embodiment, store managers no longer need to constantly monitor news or weather, and can promptly execute optimal customer attraction measures in response to sudden opportunities (namely, chances) or threats (namely, risks). Specifically, in the promotion service provision method of the present embodiment, distribution to the user U01 can be completed within a few minutes from occurrence of a situation, providing extremely high immediacy, and demonstrating remarkable technical effects in local promotions where information freshness is important. In addition, content with unique context that combines store-specific conditions and real-time external environments is more likely to attract interest of the user U01 compared to distribution of template messages, and a high conversion rate (namely, store visit rate) can be expected.

Hereinafter, a more specific description will be given of an example configuration of the promotion system 1 to which the above-described promotion service provision method according to the embodiment is applied.

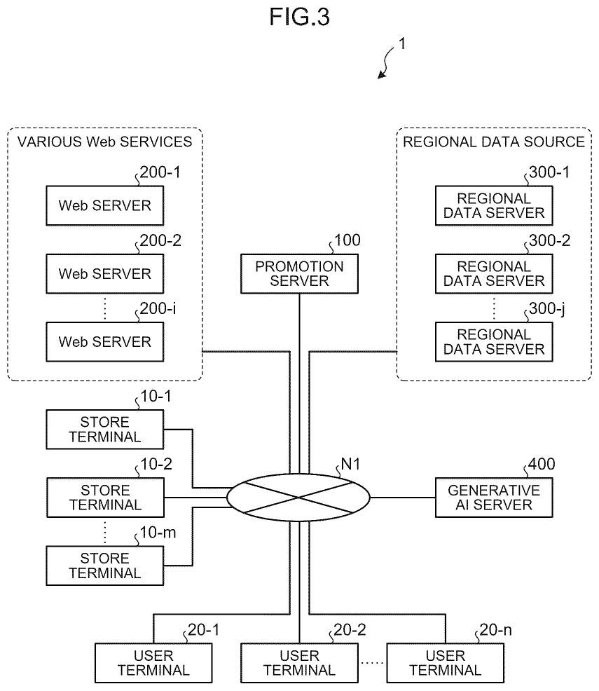

FIG. 3 is a diagram showing an example configuration of the promotion system 1 according to the embodiment. As shown in FIG. 3, the promotion system 1 includes store terminals 10-1, 10-2, . . . , 10-m (where m is a natural number), user terminals 20-1, 20-2, . . . , 20-n (where n is a natural number), and a promotion server 100. The promotion system 1 further includes web servers 200-1, 200-2, . . . , 200-i (where i is a natural number), regional data servers 300-1, 300-2, . . . , 300-j (where j is a natural number), and a generative AI server 400.

The store terminals 10, the user terminals 20, the promotion server 100, the web servers 200, the regional data servers 300, and the generative AI server 400 are communicably connected to each other via a network N1, which is an information communication network such as the Internet.

Since the store terminals 10, the user terminals 20, the promotion server 100, and the generative AI server 400 have already been described, their explanation is omitted here. The web server 200 is a server device that provides various web services such as map information services, SNS, ISP services, payment services, facility reservation services, and delivery services as shown in FIG. 1. The web server 200 is operated and managed by business operators providing various web services, and is implemented as a public cloud, for example.

The regional data server 300 is a server device that serves as a data source for various types of information in regional data sources shown in FIG. 1. At least some of the web servers 200 may also function as the regional data servers 300. The regional data server 300 is operated and managed by local governments, public institutions, business operators providing regional data, and business operators providing various web services, and is implemented as a public cloud, for example.

Next, an example configuration of the promotion server 100 will be described. FIG. 4 is a diagram showing an example configuration of the promotion server 100 according to the embodiment. As shown in FIG. 4, the promotion server 100 includes a communication unit 101, a storage unit 102, and a control unit 103.

The communication unit 101 is implemented by a network adapter or the like. The communication unit 101 is connected to the network N1 by a wired or wireless manner, and transmits and receives information with the store terminals 10, the user terminals 20, the web servers 200, the regional data servers 300, and the generative AI server 400 via the network N1.

The storage unit 102 is implemented by storage devices such as ROM (Read Only Memory), RAM (Random Access Memory), flash memory, or hard disk devices. In the example of FIG. 4, the storage unit 102 stores a customer information database 102a, a user information database 102b, a promotion information database 102c, a regional data database 102d, a cluster analysis model 102e, a cluster information database 102f, and a situation analysis model 102g.

The customer information database 102a is a database of information for identifying stores that are customers in the promotion system 1. The customer information database 102a accumulates information such as a store's business type, products that can be provided by the store, and an upper limit of discounts that can be offered. Information such as a store's business type, products that can be provided, and an upper limit of discounts may be transmitted to the promotion server 100 via the store terminal 10 and stored in the customer information database 102a.

The user information database 102b is a database of user information collected from the web server 200 through information linkage with the web server 200. The user information includes attribute information and behavioral information of each of the users U01. Each piece of the user information in the user information database 102b is used for cluster analysis by the analysis unit 103b described later.

The promotion information database 102c is a database in which promotion data generated by the generation unit 103d described later is accumulated. The promotion information database 102c may also function as an image database for image groups used in promotion data. Furthermore, the promotion information database 102c may accumulate promotion data collected from the web server 200 through information linkage with the web server 200. Each promotion data in the promotion information database 102c may be associated with evaluation values such as conversion rates measured by the evaluation unit 103f described later.

The regional data database 102d is a database of regional data collected by the collection unit 103a described later. The cluster analysis model 102e is a mathematical model or AI model used for cluster analysis by the analysis unit 103b. The cluster analysis model 102e may be, for example, a DNN (Deep Neural Network) model.

The cluster information database 102f is a database that stores cluster information obtained by using the cluster analysis model 102e. The distribution unit 103e described later identifies the target user U01 based on cluster information in the cluster information database 102f.

The situation analysis model 102g is a mathematical model or AI model used for real-time situation analysis by the analysis unit 103b described later. The situation analysis model 102g may be, for example, a DNN model.

The control unit 103 corresponds to a so-called controller or processor. The control unit 103 is implemented by a CPU (Central Processing Unit), MPU (Micro Processing Unit), GPU (Graphical Processing Unit), or the like. The control unit 103 executes an information processing program according to the embodiment stored in the storage unit 102, using RAM as a work area. The control unit 103 may also be implemented by an ASIC (Application Specific Integrated Circuit) or FPGA (Field Programmable Gate Array) or other integrated circuits.

The control unit 103 includes a collection unit 103a, an analysis unit 103b, a proposal unit 103c, a generation unit 103d, a distribution unit 103e, and an evaluation unit 103f, and realizes or executes information processing functions and operations described below.

The collection unit 103a collects various types of information from various web services via the web server 200 through the communication unit 101. The collection unit 103a also collects various types of regional data from the regional data server 300 via the communication unit 101. The collection unit 103a appropriately stores the collected information, after organizing and cleansing it, in the user information database 102b, the promotion information database 102c, and the regional data database 102d.

The analysis unit 103b performs cluster analysis and situation analysis based on various types of information collected by the collection unit 103a. The analysis unit 103b performs cluster analysis using the cluster analysis model 102e based on each user information in the user information database 102b, and aggregates analysis results in the cluster information database 102f. The analysis unit 103b also performs situation analysis using the situation analysis model 102g based on each regional data in the regional data database 102d, for example.

The proposal unit 103c detects an optimal timing for a promotion in a customer store located in an area indicated by regional data, based on result of situation analysis by the analysis unit 103b. When the proposal unit 103c detects arrival of the timing, it proposes implementation of promotion to the store terminal 10 of the relevant store via the communication unit 101. When the proposal unit 103c receives an acceptance response to such a proposal from the store terminal 10 via the communication unit 101, it instructs the generation unit 103d to generate promotion data using generative AI.

The situation analysis by the analysis unit 103b may include not only visualization of data but also “event detection” that serves as a trigger for promotion generation. Specifically, the analysis unit 103b compares time-series data accumulated in the regional data database 102d (such as normal traffic volume, average precipitation) with current values collected in real time, and when a deviation exceeds a predetermined threshold, or when specific keywords (such as “delay,” “congestion,” “cancellation”) rapidly increase in news feeds or SNS, determines that an “extraordinary situation (event)” has occurred. The proposal unit 103c uses this event detection as a trigger to initiate a promotion creation flow using generative AI for stores in the relevant area.

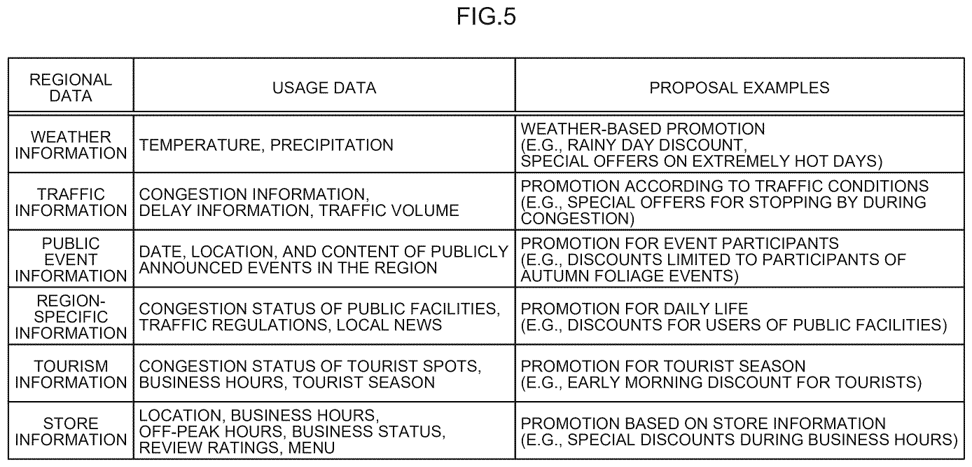

Here, the proposal unit 103c proposes implementation of a promotion using usage data in regional data and examples of promotion proposals based on such data. FIG. 5 is a diagram showing an example of usage data in regional data.

As shown in FIG. 5, among regional data, for example, weather information uses temperature, precipitation, etc. as usage data. Based on such usage data, the proposal unit 103c proposes, for example, weather-based promotions (e.g., rainy day discounts, special offers on extremely hot days).

Among regional data, for example, traffic information uses congestion information, delay information, traffic volume, etc. as usage data. Based on such usage data, the proposal unit 103c proposes, for example, promotions according to traffic conditions (e.g., special offers for stopping by during congestion).

Among regional data, for example, public event information uses a date, location, and content of publicly announced events in the region as usage data. Based on such usage data, the proposal unit 103c proposes, for example, promotions for event participants (e.g., discounts limited to participants of autumn foliage events).

Among regional data, for example, region-specific information uses usage data such as congestion status of public facilities, traffic regulations, and local news. Based on such usage data, the proposal unit 103c proposes, for example, promotions for daily life (e.g., discounts for users of public facilities).

Among regional data, for example, tourism information uses usage data such as congestion status of tourist spots, business hours, and tourist seasons. Based on such usage data, the proposal unit 103c proposes, for example, promotions for tourist seasons (e.g., early morning discounts for tourists).

Among regional data, for example, store information uses usage data such as location, business hours, off-peak hours, business status, review ratings, and menu information. Based on such usage data, the proposal unit 103c proposes, for example, promotions based on store information (e.g., special discounts during business hours).

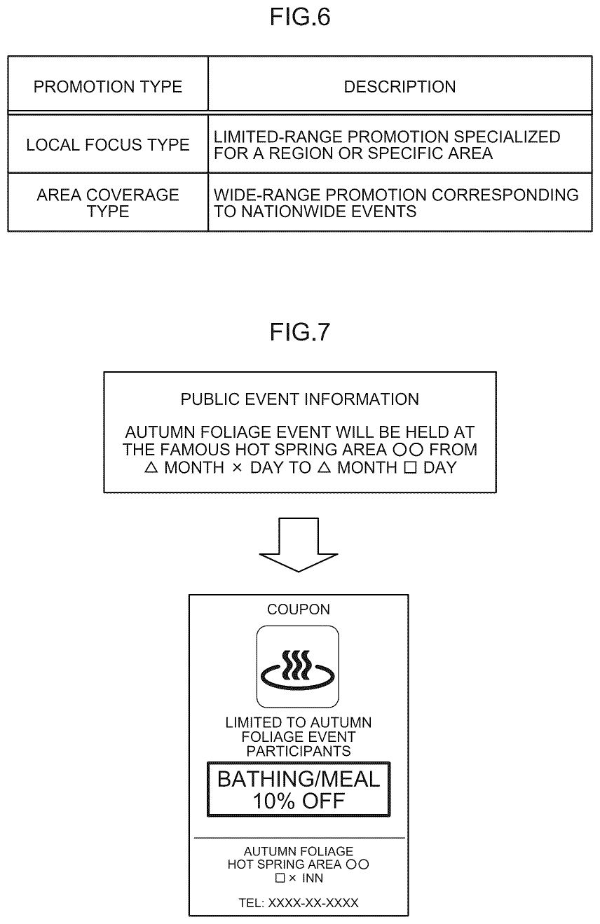

The proposal unit 103c can propose, for example, two types of promotions. FIG. 6 is an explanatory diagram of the promotion types. FIG. 7 is a diagram showing an example of area coverage type promotion.

As shown in FIG. 6, the proposal unit 103c proposes, as promotion types, for example, two types: “local focus type” and “area coverage type”. The “local focus type” refers to limited-range promotions specialized for a region or specific area. The “area coverage type” refers to wide-range promotions corresponding to nationwide events.

The specific example explained with reference to FIG. 2 corresponds to an example of the “local focus type,” as it is a limited-range promotion specialized for an area between XX Station and Δ Station. On the other hand, FIG. 7 shows an example of the “area coverage type.”

As shown in FIG. 7, suppose the promotion server 100 acquires public event information as certain regional data, such as “A fall foliage event will be held at the famous hot spring area XX from Δ month×day to Δ month □ day.” Then, the proposal unit 103c proposes promotions for event participants to the store terminals 10 of hot spring facilities and accommodation facilities located around hot spring area XX. As a result, FIG. 7 shows an example in which a coupon for discounts limited to participants of the fall foliage event is generated as promotion data.

In such an example, the promotion server 100 can target not only the users U01 around the hot spring area XX, but also the users U01 nationwide who are interested in the hot spring area XX or autumn foliage viewing. In other words, the promotion server 100 can distribute promotion data to the user terminals 20 over a wide range beyond an area where a store is located, according to a content of the regional data.

Returning to explanation of FIG. 4. The generation unit 103d generates a prompt for the generative AI server 400 to generate promotion data for a store that has accepted implementation of promotion, using, for example, information linked with various web services and regional data.

The generation unit 103d transmits the generated prompt to the generative AI server 400 via the communication unit 101. The generation unit 103d receives promotion data generated by the generative AI server 400 in response to the transmitted prompt via the communication unit 101.

The prompt (namely, instruction information) transmitted by the generation unit 103d to the generative AI server 400 includes at least the following elements:
(1) “Context information”: An area situation detected by the analysis unit 103b (e.g., ‘Large summer festival being held around Station A’, ‘Extreme heat with temperatures above 35° C.’).
(2) “Store constraint conditions”: A store's business type, products that can be provided, and discount upper limit settings extracted from the customer information database 102a.
(3) “Target persona”: Attributes of distribution target users identified by cluster analysis (e.g., ‘Women in their 20s, event enthusiasts’).
(4) “Generation instructions”: Output tone (such as friendliness) and character count restrictions.

The generative AI model integrally processes these structured data or unstructured text, infers and outputs catchphrases and coupon content that can motivate users to visit a store in a given situation. Note that elements included in a prompt transmitted by the generation unit 103d to the generative AI server 400 are not limited to the above.

The generation unit 103d provides a generative AI model with a system prompt specifying a role (Role), such as “You are an excellent store marketing manager,” and embeds parameters such as “Current situation: {Traffic information: X line suspended}”, “Action to propose: {Encourage store visit}” in natural language format as a user input. This enables highly accurate output specialized for a unique purpose of this system, even when using a general-purpose large language model.

The generation unit 103d presents promotion data received from the generative AI server 400 to the store terminal 10 via the communication unit 101 for confirmation by the operator M01. The generation unit 103d repeats generation and confirmation of promotion data until approval is obtained from the operator M01. When approval is obtained from the operator M01, the generation unit 103d instructs the distribution unit 103e to distribute the promotion data. The generated result presented to the store terminal 10 may be displayed not only as simple text but also as an editable object. The operator M01 can make minor adjustments to a generated catchphrase or discount amount (e.g., “50 yen OFF”) by operating on a screen. The generation unit 103d presents a “regenerate button” to the store terminal 10, and if an operator rejects the proposal, it can immediately regenerate and present different variations of a promotion proposal by changing parameters such as temperature. This allows flexible modification and retry even if an output generated by the generative AI server 400 does not match a store's policy, ensuring

operational safety in actual use. The distribution unit 103e identifies a cluster of the target users U01 based on promotion data to be distributed and cluster information in the cluster information database 102f. The distribution unit 103e distributes promotion data to the user terminals 20 corresponding to the identified cluster via the communication unit 101.

The evaluation unit 103f measures, via the communication unit 101, the number of clicks and the like on promotion data from the user terminals 20, and calculates evaluation values such as conversion rate. The evaluation unit 103f associates the calculated evaluation values with the promotion data and stores them in the promotion information database 102c. The evaluation unit 103f also appropriately links evaluation results with the web server 200. Alternatively, the evaluation unit 103f may appropriately feed-back the evaluation results to reinforcement learning of the cluster analysis model 102e or the situation analysis model 102g.

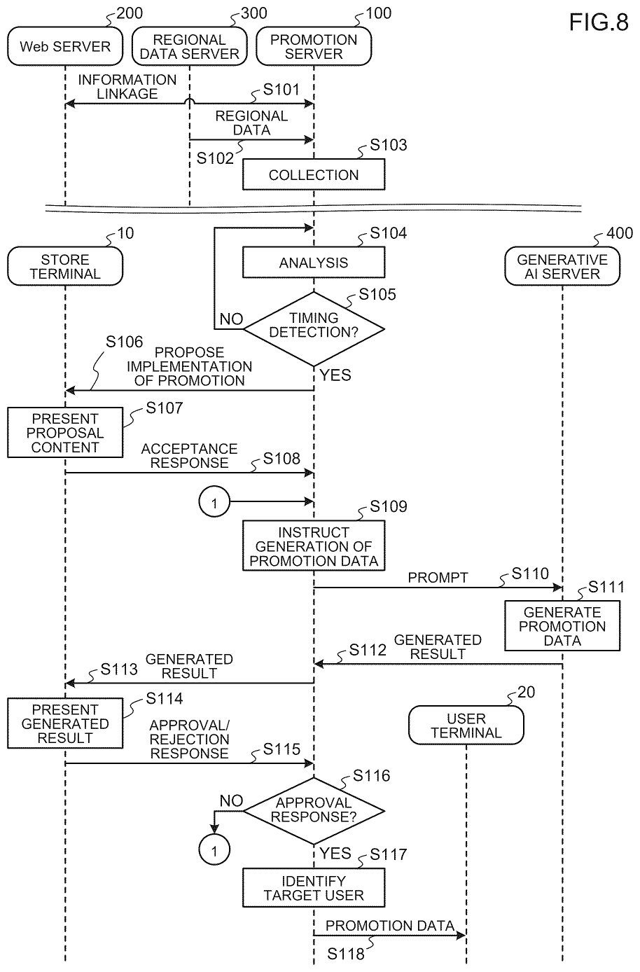

Next, a processing sequence executed by the promotion system 1 according to the embodiment will be described with reference to FIG. 8. FIG. 8 is a diagram showing a processing sequence executed by the promotion system 1 according to the embodiment.

As shown in FIG. 8, in the promotion system 1, the promotion server 100 appropriately (for example, in real time) links information with the web server 200 (Step S101). The promotion server 100 also appropriately (for example, in real time) receives regional data from the regional data server 300 (Step S102). Thus, the promotion server 100 collects various types of information from the web server 200 and various types of regional data from the regional data server 300 (Step S103).

The promotion server 100 performs cluster analysis and real-time situation analysis based on the collected information (Step S104). Then, the promotion server 100 determines whether an optimal timing for a promotion in a customer store located in an area indicated by the regional data has been detected based on result of the situation analysis (Step S105).

If such timing has not been detected (Step S105, No), the promotion server 100 repeats the processing from Step S104. If the timing has been detected (Step S105, Yes), the promotion server 100 proposes implementation of promotion to the store terminal 10 of a relevant store (Step S106).

The store terminal 10 presents a proposal content of such a proposal (Step S107). When the operator M01 performs an operation to accept the presented proposal content, the store terminal 10 transmits an acceptance response to the promotion server 100 (Step S108).

Upon receiving such an acceptance response, the promotion server 100 instructs the generative AI server 400 to generate promotion data (Step S109). Specifically, the promotion server 100 generates a prompt for the generative AI server 400 to generate promotion data for a store that has accepted the implementation of the promotion, using, for example, information linked with various web services

and regional data. The promotion server 100 transmits the generated prompt to the generative AI server 400 (Step S110).

The generative AI server 400 generates promotion data based on a prompt received from the promotion server 100 (Step S111), and transmits the generated result to the promotion server 100 (Step S112).

When the promotion server 100 receives generated result from the generative AI server 400, it transmits the generated result to the store terminal 10 for confirmation (Step S113). The store terminal 10 presents the generated result (Step S114).

Upon receiving the presented generated result, the operator M01 performs an operation to approve or reject it. The store terminal 10 transmits an approval/rejection response to the promotion server 100 according to such operation (Step S115).

The promotion server 100 determines whether an approval response has been received (Step S116). If an approval response has not been received (Step S116, No), the promotion server 100 repeats the processing from Step S109.

If an approval response has been received (Step S116, Yes), the promotion server 100 identifies the target user U01 based on approved promotion data and cluster information in the cluster information database 102f (Step S117). Then, the promotion server 100 transmits promotion data to the user terminal 20 of the identified user U01 (Step S118).

Note that, in the above-described embodiment, an example configuration is given in which the promotion server 100 and the generative AI server 400 are separate devices, but the promotion server 100 and the generative AI server 400 may be configured as a single device.

In the above-described embodiment, an example is given in which, when the promotion server 100 detects the timing for a promotion, it exchanges proposals and acceptance with the store terminal 10, but such exchanges are not necessarily required. For example, when the promotion server 100 detects a timing for a promotion, it may automatically generate promotion data, and presentation and approval of promotion data may serve as acceptance of a proposal.

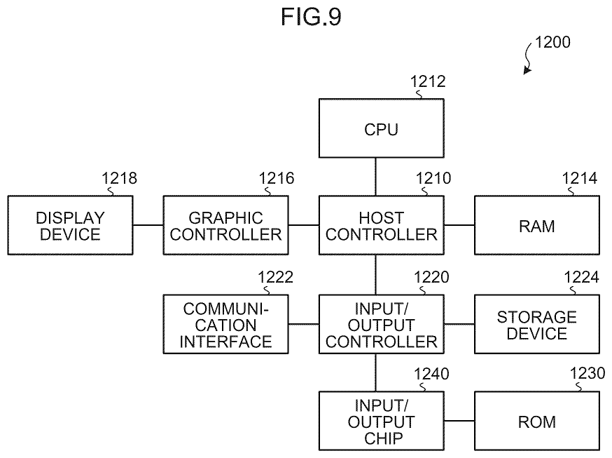

Next, a hardware configuration of a computer 1200 functioning as the promotion server 100 will be described with reference to FIG. 9. FIG. 9 is a schematic diagram showing an example hardware configuration of the computer 1200 functioning as the promotion server 100. A program installed in the computer 1200 can cause the computer 1200 to function as one or more “units” of the apparatus according to the present embodiment, or cause the computer 1200 to execute operations or the one or more “units” associated with an apparatus according to the present embodiment, and/or cause the computer 1200 to execute a process or stages of the process according to the present embodiment. Such a program may be executed by the CPU 1212 to execute specific operations associated with some or all of blocks in flowcharts and block diagrams described in this specification.

The computer 1200 according to the present embodiment includes a CPU 1212, a RAM 1214, and a graphic controller 1216, which are interconnected by a host controller 1210. The computer 1200 also includes input/output units such as a communication interface 1222, a storage device 1224, a DVD drive, and an IC card drive, which are connected to the host controller 1210 via an input/output controller 1220. The DVD drive may be a DVD-ROM drive or a DVD-RAM drive, etc. The storage device 1224 may be a hard disk drive or a solid-state drive, etc. The computer 1200 also includes input/output units such as a ROM 1230 and a keyboard, which are connected to the input/output controller 1220 via an input/output chip 1240.

The CPU 1212 operates according to programs stored in the ROM 1230 and the RAM 1214, thereby controlling each unit. The graphic controller 1216 acquires image data generated by the CPU 1212 in a frame buffer provided in the RAM 1214 or in itself, and causes the image data to be displayed on the display device 1218.

The communication interface 1222 communicates with other electronic devices via a network. The storage device 1224 stores programs and data used by the CPU 1212 in the computer 1200. The DVD drive reads programs or data from DVD-ROMs and provides them to the storage device 1224. The IC card drive reads programs and data from IC cards and/or writes programs and data to IC cards.

The ROM 1230 stores, for example, a boot program executed by the computer 1200 upon activation, and/or programs dependent on the hardware of the computer 1200. The input/output chip 1240 may also connect various input/output units to the input/output controller 1220 via USB ports, parallel ports, serial ports, keyboard ports, mouse ports, etc.

Programs are provided by computer-readable storage media such as DVD-ROMs or IC cards. Programs are read from computer-readable storage media, installed in the storage device 1224, the RAM 1214, or the ROM 1230, which are also examples of computer-readable storage media, and executed by the CPU 1212. The information processing described in these programs is read by the computer 1200 and enables cooperation between programs and various types of hardware resources described above. The apparatus or method may be configured to realize information operations or processing by using the computer 1200.

For example, when communication is performed between the computer 1200 and an external device, the CPU 1212 executes a communication program loaded into the RAM 1214, and based on the processing described in the communication program, may instruct the communication interface 1222 to perform communication processing. Under control of the CPU 1212, the communication interface 1222 reads transmission data stored in a transmission buffer area provided in the RAM 1214, the storage device 1224, DVD-ROM, or IC card, which are recording media, transmits the read transmission data to a network, and/or writes received data received from a network to a reception buffer area provided on the recording media.

The CPU 1212 may cause all or necessary parts of files or databases stored in external recording media such as the storage device 1224, DVD drive (DVD-ROM), or IC card to be read into the RAM 1214, and perform various types of processing on data in the RAM 1214. The CPU 1212 may then write back the processed data to the external recording media.

Various types of programs, data, tables, and databases may be stored in recording media and subjected to information processing. The CPU 1212 may perform various types of processing on data read from the RAM 1214, including various types of operations, information processing, conditional judgments, conditional branches, unconditional branches, information search/replacement, etc., as described throughout this disclosure and specified by the instruction sequence of the program, and write back the results to RAM 1214. The CPU 1212 may also search for information in files, databases, etc. in the recording media. For example, when multiple entries having attribute values of a first attribute associated with attribute values of a second attribute are stored in the recording media, the CPU 1212 may search for entries matching a specified condition for an attribute value of the first attribute among multiple entries, read an attribute value of a second attribute stored in the entry, and thereby obtain an attribute value of the second attribute associated with the first attribute that satisfies a predetermined condition.

The above-described programs or software modules may be stored on the computer 1200 or on computer-readable storage media near the computer 1200. Recording media such as hard disks or RAM provided in a server system connected to a dedicated communication network or the Internet can be used as computer-readable storage media, thereby providing programs to the computer 1200 via a network.

Blocks in flowcharts and block diagrams in the present embodiment may represent stages of a process in which operations are executed or “units” of a device that have a role of executing operations. Specific stages and “units” may be implemented by dedicated circuits, programmable circuits supplied with computer-readable instructions stored on computer-readable storage media, and/or processors supplied with computer-readable instructions stored on computer-readable storage media. Dedicated circuits may include digital and/or analog hardware circuits, and may include integrated circuits (ICs) and/or discrete circuits. Programmable circuits may include reconfigurable hardware circuits such as field programmable gate arrays (FPGAs) and programmable logic arrays (PLAs), which include logical AND, logical OR, exclusive OR, NAND, NOR, and other logic operations, flip-flops, registers, and memory elements.

Computer-readable storage media may include any tangible device capable of storing instructions to be executed by an appropriate device, and as a result, computer-readable storage media having instructions stored therein comprise a product including instructions that may be executed to create means for executing the operations specified in flowcharts or block diagrams. Examples of computer-readable storage media may include electronic storage media, magnetic storage media, optical storage media, electromagnetic storage media, semiconductor storage media, and the like. More specific examples of computer-readable storage media may include floppy disks, diskettes, hard disks, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile discs (DVD), Blu-ray discs, memory sticks, integrated circuit cards, and the like.

Computer-readable instructions may include assembler instructions, instruction set architecture (ISA) instructions, machine instructions, machine-dependent instructions, microcode, firmware instructions, state-setting data, or source code or object code written in any combination of one or more programming languages, including object-oriented programming languages such as Smalltalk, JAVA, C++, and conventional procedural programming languages such as the “C” programming language or similar programming languages.

Computer-readable instructions may be provided locally or via a local area network (LAN), the Internet, or other wide area network (WAN) to a general-purpose computer, special-purpose computer, or other programmable data processing device processor, or programmable circuit, to generate means for executing the operations specified in the flowcharts or block diagrams by executing the computer-readable instructions. Examples of processors include computer processors, processing units, microprocessors, digital signal processors, controllers, microcontrollers, and the like.

The present invention has been described using embodiments, but the technical scope of the present invention is not limited to the scope described in the above embodiments. It is apparent to those skilled in the art that various changes or improvements can be made to the above embodiments. It is clear from the description of the claims that embodiments with such changes or improvements may also be included in the technical scope of the present invention.

The order of execution of operations, procedures, steps, and stages in the apparatus, system, program, and

method shown in the claims, specification, and drawings is not necessarily fixed unless explicitly stated as “prior to” or “preceding,” and unless the output of a previous process is used in a subsequent process, it should be noted that the order may be implemented arbitrarily. Even if terms such as “first,” “next,” etc. are used for convenience in describing the operation flow in the claims, specification, and drawings, this does not mean that implementation in that order is essential.

What is claimed is:

1. An information processing apparatus comprising a control unit configured to:
collect regional data for each region;
analyze a situation of an area where a customer store is located based on the collected regional data;
in a case where detecting a timing for a promotion for the store based on an analysis result of the area situation, instruct a generative AI to generate promotion data for the promotion;
present the promotion data generated by the generative AI to a store terminal of the store; and
in a case where an approval response to the promotion data is obtained from the store terminal, distribute the promotion data to user terminals used by general users.

2. The information processing apparatus according to claim 1, wherein
the control unit is further configured to:
when the timing is detected, present proposal content for implementing the promotion to the store terminal; and
when an acceptance response to the proposal content is obtained from the store terminal, instruct the generative AI to generate the promotion data.

3. The information processing apparatus according to claim 1, wherein
the control unit is further configured to:
when a rejection response to the promotion data is obtained from the store terminal, instruct the generative AI to regenerate the promotion data until an approval response is obtained from the store terminal.

4. The information processing apparatus according to claim 1, wherein
the control unit is further configured to:
cause the generative AI to generate the promotion data using information linked with web services and the regional data.

5. The information processing apparatus according to claim 4, wherein
the linked information includes attribute information and behavioral information of the user, and
the control unit is further configured to:
perform cluster analysis based on the attribute information and the behavioral information; and
identify the user terminal to which the promotion data is to be distributed based on the promotion data and the analysis result of the cluster analysis.

6. The information processing apparatus according to claim 5, wherein
the control unit is further configured to:
distribute the promotion data to user terminals located beyond the area according to a content of the regional data.

7. The information processing apparatus according to claim 5, wherein
the control unit is further configured to:
measure an effect of the promotion based on the behavioral information in response to the distributed promotion data; and
feed-back a measurement result to the analysis of the area situation and the cluster analysis.

8. The information processing apparatus according to claim 1, wherein
the regional data includes at least one of weather information, traffic information, public event information, region-specific information, tourism information, and store information for each region.

9. An information processing method executed by a control unit of an information processing apparatus, the method comprising:
collecting regional data for each region;
analyzing a situation of an area where a customer store is located based on the collected regional data;
in a case where detecting a timing for a promotion for the store based on an analysis result of the area situation, instructing a generative AI to generate promotion data for the promotion;
presenting the promotion data generated by the generative AI to a store terminal of the store; and
in a case where an approval response to the promotion data is obtained from the store terminal, distributing the promotion data to user terminals used by general users.

10. A non-transitory computer-readable recording medium storing therein an information processing program for causing a computer to execute a process comprising:
collecting regional data for each region;
analyzing a situation of an area where a customer store is located based on the collected regional data;
in a case where detecting a timing for a promotion for the store based on an analysis result of the area situation, instructing a generative AI to generate promotion data for the promotion;
presenting the promotion data generated by the generative AI to a store terminal of the store; and
in a case where an approval response to the promotion data is obtained from the store terminal, distributing the promotion data to user terminals used by general users.
